(19) United States
(12) Patent Application Publication
(10) Pub. No.: US 2010/0319198 A1
(43) Pub. Date: Dec. 23, 2010

(54) BLADE CARTRIDGE GUARD COMPRISING AN ARRAY OF FLEXIBLE FINS HAVING VARYING STIFFNESS

(76) Inventors: Robert Harold Johnson, Melrose, MA (US); Christian Reber Wester, Somerville, MA (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/796,919

(22) Filed: Jun. 9, 2010

Related U.S. Application Data
(60) Provisional application No. 61/187,840, filed on Jun. 17, 2009.

(51) Int. Cl. B26B 21/22; B26B 21/40

(52) U.S. Cl. 30/34.2; 30/50

(57) ABSTRACT

A shaving blade cartridge containing a guard on its leading edge is provided. The guard employs an array of flexible fins. There is at least one change in stiffness among the different fins situated within the array.

### CROSS REFERENCE TO RELATED APPLICATIONS

This application claims the benefit of U.S. Provisional application No. 61/187,840, filed on Jun. 11, 2009.

### FIELD OF THE INVENTION

The present invention is directed to blade cartridges and razors employing such blade cartridges. The cartridges contain a guard on its leading edge, which comprises an array of flexible fins. There is at least one change in stiffness among the different fins situated within the array.

### BACKGROUND OF THE INVENTION

Utilization of guards on the leading edge of razor blade cartridges is well known. Many guard designs contain a series of individual fins that are made from elastomeric materials, enabling them to flex back and forth as the blade cartridge is moved over the skin surface. The fins are designed to stimulate and stretch the skin in front of the blades to improve comfort and proper positioning of the skin for cutting of hairs growing outwardly from the skin. In addition to this function, the first fin or first few fins (that is, the fins furthest away from or distal to the blades) also serve to remove excess shave preparation from the skin prior to blade interaction. The possibility and/or historical experience with irritation and nicks and cuts may cause some consumers to apply an excessive amount of shave preparation to their skin. The significant amount of preparation can however create too much of a cushion between the blade and the skin to achieve a satisfactorily close shave.

### SUMMARY OF THE INVENTION

Applicants have discovered that the flexibility needs of the fins conducting the separate functions of removing excess shave preparation and stimulating/stretching the skin can be at odds with each other. In particular, applicants have discovered that while it can be beneficial to employ moderately pliable fins for stimulating and stretching the skin, this level of flexibility can cause the fins to “slide” over a layer of shave preparation rather than “pushing” the preparation out of the way. Furthermore, if the initial fin or fins fail to adequately remove the excess shaving preparation, the remaining fins cannot make good contact with the skin to perform the function of stimulating and stretching the skin. But including relatively stiff fins throughout the array of fins to ensure preparation removal may lead to skin irritation, both from the guard itself and from close blade interaction with the skin. Applicants accordingly have designed an improved guard including a plurality of fins that comprises one or more distal fins that are stiffer than one or more proximal fins, wherein the plurality of fins can collectively remove a targeted amount of shave preparation and position the skin and hair for a close and comfortable shave.

### BRIEF DESCRIPTION OF THE DRAWINGS

While the specification concludes with claims particularly pointing out and distinctly claiming the subject matter which is regarded as forming the present invention, it is believed that illustrative embodiments of the present invention may be better understood from the following description taken in conjunction with the accompanying drawings, in which:

FIG. 1 is a perspective view of a razor embodiment of the present invention;

FIG. 2 is a perspective view of a blade cartridge embodiment of the present invention;

FIG. 3 is a partial cross-sectional view of the blade cartridge of FIG. 2; and

FIG. 4 is a partial cross-sectional view of another blade cartridge embodiment provided by the present invention.

### DETAILED DESCRIPTION OF THE INVENTION

The present invention may be understood more readily by reference to the following detailed description of illustrative and preferred embodiments. It is to be understood that the scope of the claims is not limited to the specific components, methods, conditions, devices, or parameters described herein, and that the terminology used herein is not intended to be limiting of the claimed invention. Also, as used in the specification, including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent basis “about,” it will be understood that the particular values form another embodiment. All ranges are inclusive and combinable.

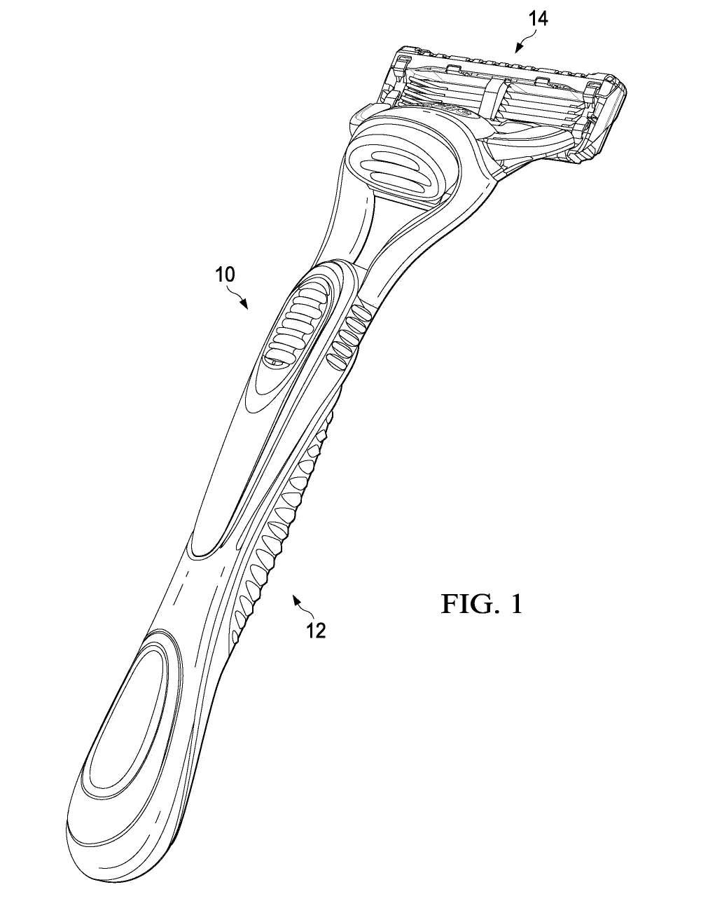

Referring now to the figures and in particular to FIG. 1, an exemplary razor 10 is shown, which includes an exemplary handle 12 and an exemplary blade cartridge 14. The razors of the present invention may be designed to employ and receive replaceable blade cartridges. The razors included herein may also have blade cartridges that are designed to be permanently affixed to the handle, wherein the entire razor is discarded when its perceived effective use is deemed to have been depleted. Handle 12 can be made from a thermoplastic material and by any methods known to the skilled artisan for forming thermoplastic materials. By way of example only, the handle or parts thereof can be injection molded from a polyolefin plastic. The handle can comprise a single thermoplastic material or multiple thermoplastic materials (including thermoplastic elastomers) via multi-shot molding techniques, including the use of rotating mold assemblies, such as those described in U.S. Pat. Nos. 6,783,346; 7,150,845; 7,320,591; and 7,452,202, and PCT published application no. WO 2007/096309.

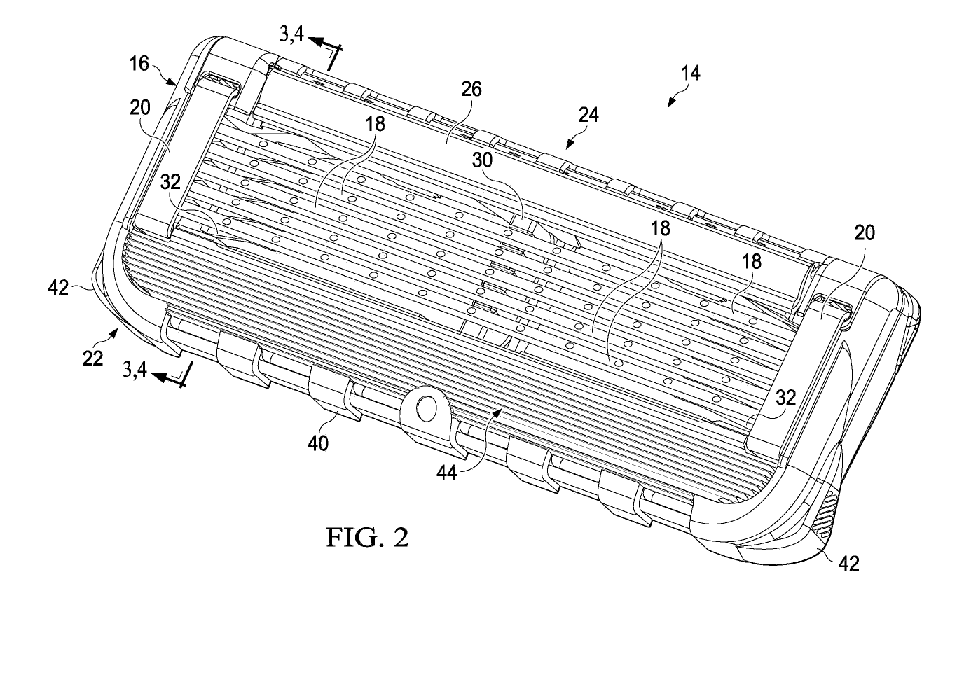

An enlarged view of blade cartridge 14 is shown in FIG. 2. Blade cartridge 14 has a housing 16, five cutting blades 18 supported by the housing, clips 20 for retaining the blades in the housing, a guard 22, and a cap 24 that includes a lubricating strip 26. Housing 16 can be made from a thermoplastic material, such as, for example, polyethylene terephthalate, polyethylene, and polypropylene. Known plastic forming techniques (e.g., injection molding) may be used to manufacture the housing. Blades 18 are supported by a central support member 30 and side support members 32. Blades 18 are preferably made from a metal, such as, for example, steel. The cutting edges of blades 18 may optionally contain a coating material, such as those described in U.S. Pat. Nos. 5,295,305; 5,799,549; 5,992,268; 6,684,513; and 6,866,894. Although exemplary blade cartridge 14 is shown with five blades, the number can vary, with more than five blades and with as few as a single blade being possible. Clips 20 are employed for securably retaining the blades within housing 16. Clips 20 may be made from a variety of materials, including, for example, 5052-H16 Aluminum. Lubricating strip 26 can be made from a material comprising a mixture of a hydrophobic material and a water leachable, hydrophilic polymer, as is known in the art, and as described by way of example in U.S. Pat. Nos. 5,113,585 and 5,454,164.

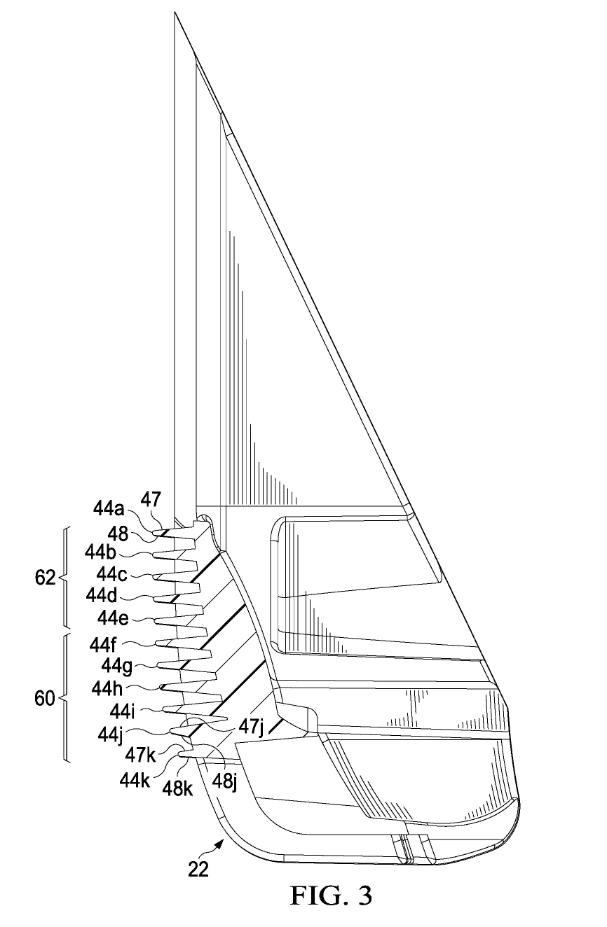

Exemplary guard 22 will be further described with reference to FIGS. 2 and 3. Guard 22 comprises a front portion 40, side portions 42, and an array of fins 44. In one embodiment, all of the features of the guard are made from the same material, and in other embodiments, the features may be made from different materials. The guard can be made from elastomer or non-elastomer thermoplastic materials, or a mixture of the two. The guard can be manufactured separately from the cartridge housing, or can be co-molded with the same. Fins 44 are designed to have some degree of flexibility, and with this in mind, can be made from an elastomeric material or a blended material incorporating an elastomeric material. The fins may also be made from relatively “soft” thermoplastic materials that are generally not considered elastomers, such as, for example, low molecular weight polyethylene. A representative, and non-limiting, list of suitable materials for the fins includes synthetic elastomers based on SEBS, SEPS, TPV, or thermoplastic polyurethane type. The fin material can have a hardness property of from about 28 to about 60 Shore A hardness. Exemplary fins have a tip to base height of from about 0.3 mm to about 1.0 mm, a cross-sectional width dimension that is measured 0.2 mm from the fin tip of from about 0.15 mm to about 0.7 mm, having opposing sidewalls 47 and 48, are spaced center-to-center from about 0.1 mm to about 2.0 mm. Where the fins have a different base reference on either side of the tip (that is, have different sidewall lengths), then the height can be calculated as the average of the two measurements from base to tip. See, for example, the two fins 44j and 44k farthest from blades 18 that have a different base to tip dimension associated with each of the fins by employing different length side walls. Fin 44j has a relatively long sidewall length 47j and a relatively short sidewall length 48j. And fin 44k has a relatively long sidewall length 48k and a relatively short sidewall length 47k.

The guard can serve one or more functions, including, for example, removing excess shaving preparation from the skin, and stretching and stimulating the skin prior to blade exposure. As noted above, Applicants have discovered that the flexibility needs of the fins conducting the separate functions of removing excess shave preparation and stimulating/stretching the skin can be at odds with each other. To address this Applicant-identified design compromise, the array of fins has at least one change in stiffness among the different fins situated within the array. In one embodiment, a sub-array of one or more fins 60 that are farthest or distal to the blades are stiffer than a sub-array of one or more fins 62 that are closest or proximate to the blades. Being relatively stiffer, fin(s) 60 can function to effectively remove excess shaving preparation prior to engagement of fin(s) 62 and blades 18. The relatively greater pliability/flexibility of fin(s) 62 then can allow for fin(s) 62 to effectively stimulate and/or stretch the skin to prepare it for blade passage. If excess shaving preparation is not removed from the skin by fin(s) 60, then fin(s) 62 may be unable to contact the skin sufficiently to prepare the skin and hair for cutting.

There are a number of different execution approaches for making fin(s) 60 to be stiffer than fin(s) 62. For example, fin(s) 60 may have a different size and/or shape (e.g., a different base to tip height), have a different cross-sectional profile, have a different material mass, or be made from a different material in comparison to fin(s) 62. In one embodiment, fin(s) 60 have a base to tip height dimension that is at least 20%, 30%, 40%, 50%, 60%, 70%, or 80% shorter than that of fin(s) 62. Another approach that may increase directional stiffness of one or more fins is to significantly vary the opposing sidewall lengths of the fins. With reference to fins 44j and 44k in FIG. 3, opposing sidewalls 47j and 48j of fin 44j, and opposing sidewalls 47k and 48k of fin 44k, significantly differ in length. The percent difference in sidewall length can be, for example, at least 20%, 30%, 40%, 50%, 60%, 70%, or 80%. The fin sidewall (e.g., 47j) that faces the blades 18 may be longer than the fin sidewall (e.g., 48j) that opposes the blades 18. Alternately, the fin sidewall (e.g., 47k) that faces the blades 18 may be shorter than the fin sidewall (e.g., 48k) that opposes the blades 18.

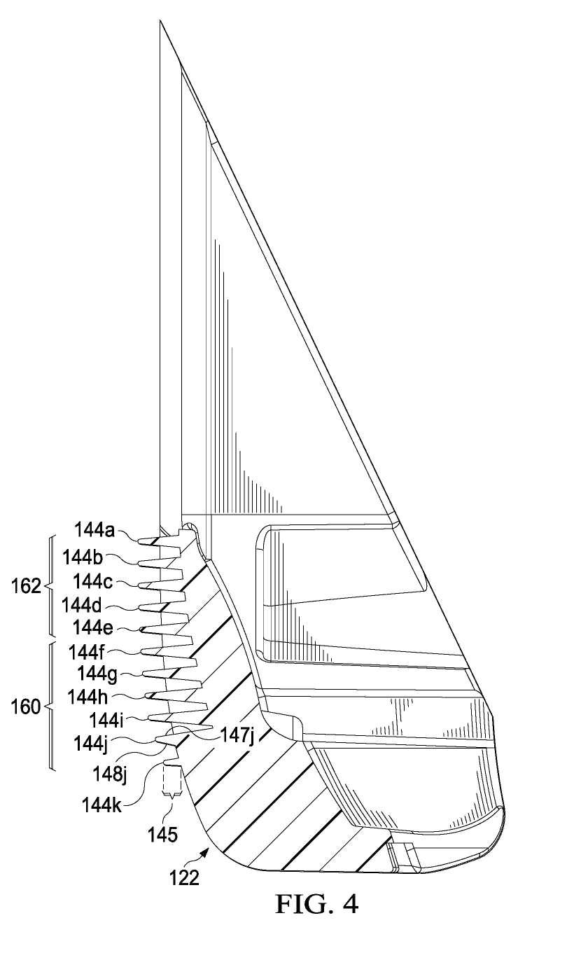

With reference to FIG. 4, another exemplary guard 122 is shown. Guard 122 has an array of fins 144, which includes a sub-array of one or more fins 160 that are situated farthest or distal to the blades (not shown) and a sub-array of one or more fins 162 that are situated closer or proximate to the blades. As can be seen in FIG. 4, fin 144k has a height dimension 145 that is significantly less than that of fin 144a. Also, fin 144j has a relatively long sidewall 147j and a relatively short sidewall 148j.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ”

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1) A shaving blade cartridge, comprising:
(a) a housing;
(b) one or more blades supported by the housing; and
(c) a guard member disposed on the housing, the guard member comprising a plurality of fins comprising a first fin that is proximate to the one or more blades and a second fin that is distal to the one or more blades, wherein the second fin has a shorter height dimension as compared to that of the first fin.

2) The shaving blade cartridge of claim 1, wherein the second fin has a height dimension that is at least 20%, 30%, 40%, 50%, 60%, 70%, or 80% shorter than that of the first fin.

3) The shaving blade cartridge of claim 1, wherein at least some of the plurality of fins are made from an elastomer having a Shore A hardness of from about 20 to about 60.

4) The shaving blade cartridge of claim 1, wherein at least some of the fins are made from a thermoplastic elastomer.

5) The shaving blade cartridge of claim 4, wherein the thermoplastic elastomer is selected from the group consisting of styrenic block copolymers, polyurethanes, and mixtures thereof.

6) The shaving blade cartridge of claim 1, wherein the housing and the guard are made from a co-injection molding process.

7) A shaving blade cartridge, comprising:
(a) a housing;
(b) one or more blades supported by the housing; and
(c) a guard member disposed on the housing, the guard member comprising a plurality of fins at least one of which having a first sidewall that is a different length than a second sidewall.

8) The shaving blade cartridge of claim 7, wherein the percent difference in length of the first sidewall compared to the second sidewall is at least 20%, 30%, 40%, 50%, 60%, 70%, or 80%.

9) The shaving blade cartridge of claim 7, wherein the first sidewall faces the one or more blades and the second sidewall opposes the one or more blades, and wherein the first sidewall is longer than the second sidewall.

10) The shaving blade cartridge of claim 7, wherein the first sidewall faces the one or more blades and the second sidewall opposes the one or more blades, and wherein the first sidewall is shorter than the second sidewall.

11) The shaving blade cartridge of claim 7, wherein at least some of the plurality of fins are made from an elastomer having a Shore A hardness of from about 20 to about 60.

12) The shaving blade cartridge of claim 7, wherein at least some of the fins are made from a thermoplastic elastomer.

13) The shaving blade cartridge of claim 12, wherein the thermoplastic elastomer is selected from the group consisting of styrenic block copolymers, polyurethanes, and mixtures thereof.

14) The shaving blade cartridge of claim 7, wherein the housing and the guard are made from a co-injection molding process.

15) A shaving blade cartridge, comprising:
(a) a housing;
(b) one or more blades supported by the housing; and
(c) a guard member disposed on the housing, the guard member comprising a plurality of fins comprising a first fin that is proximate to the one or more blades and a second fin that is distal to the one or more blades, wherein the second fin has opposing first and second sidewalls, and wherein the first sidewall has length that is at least 20% different than that of that of the second sidewall.

16) The shaving blade cartridge of claim 15, wherein at least some of the plurality of fins are made from an elastomer having a Shore A hardness of from about 20 to about 60.

17) The shaving blade cartridge of claim 15, wherein at least some of the fins are made from a thermoplastic elastomer.

18) The shaving blade cartridge of claim 17, wherein the thermoplastic elastomer is selected from the group consisting of styrenic block copolymers, polyurethanes, and mixtures thereof.

19) The shaving blade cartridge of claim 15, wherein the housing and the guard are made from a co-injection molding process.
